(19) United States
(12) Patent Application Publication
(10) Pub. No.: US 2011/0035275 A1
(43) Pub. Date: Feb. 10, 2011

(54) METHOD AND APPARATUS FOR EMBEDDED GRAPHICAL ADVERTISING

(76) Inventors: Scott Frankel, Los Angeles, CA (US); Greg Lam, Los Angeles, CA (US)

Correspondence Address: BROOKS KUSHMAN P.C., 1000 TOWN CENTER, TWENTY-SECOND FLOOR, SOUTHFIELD, MI, 48075, US

(21) Appl. No.: 12/535,767

(22) Filed: Aug. 5, 2009

(51) Int. Cl. G06Q 30/00; G06F 3/048

(52) U.S. Cl. 705/14.45; 715/760; 715/205; 715/808; 715/856; 705/27.2

(57) ABSTRACT

A method of electronic advertising includes determining a plurality of portions of an image that are to be designated as mouse-clickable portions. The mouse-clickable portions each correspond to a single item to be offered for sale. The method includes designating each of the plurality of portions as mouse-clickable portions and providing a hyper-link in conjunction with each of the mouse-clickable portions. When a given mouse-clickable portion is clicked on by a user, the hyper-link causes a web browser to display a site offering the item shown in the mouse-clickable portion for sale.

### TECHNOLOGICAL FIELD

The illustrative embodiments generally relate to a method and apparatus for embedded graphical advertising.

### BACKGROUND AND SUMMARY OF ILLUSTRATIVE EMBODIMENTS

Product placement has played a key role in advertising for decades. For example, in many movies, advertisers will pay a producer or director to place an object in a movie with a label displayed prominently. Viewers watching the movie will have their attention intentionally or incidentally drawn to the products, and the advertisers will thereby receive attention for their products.

Consumers wishing to purchase the products shown in the movies, however, must go out to the store or online on the Internet to find the products. Certain products may be labeled and easy to find, such as, for example, a can of COCA-COLA. Because the product can be easily referenced and found by the consumer, the advertiser will likely be willing to pay a fair amount of money for the product to be shown in the movie.

On the other hand, there are hundreds of items shown in movies that do not have labels visually associated with them. Because it may be difficult or even impossible for the average consumer to find out who made these products, or how to purchase them, the designers/advertisers may not be willing to pay much or anything for placement of these products in a movie.

Similarly, product placement can be done in advertising in mediums such as newspapers and magazines. In one illustrative example, a photograph in a newspaper or magazine may be designed to show a particular product. In such a display, the product is the focus of the image and is displayed prominently. Typically there is additionally some information associated with the product, such as where or how to buy the product.

In another example, a photograph of, for example, a model wearing a particular outfit may be shown. Each item in the outfit may be for sale. In some magazines, there is a listing of the various items in the outfit, and/or costs, and/or places where the items may be purchased (such as websites).

In both of the preceding examples, advertisers are usually willing to pay for the display of the images in a magazine or newspaper because, like in the movies, people viewing the photograph can determine what products are being advertised and where to purchase those products.

In yet a further example, a photograph of, for example, a celebrity may be shown. The photograph may be displayed in conjunction with a feature on that celebrity or on celebrities in general (such as a red carpet event). Or the photograph could even be one taken by, for example, paparazzi.

Typically, in these photographs, the products worn by the celebrity and/or in the background are not the focus of the photograph and many times are unidentified. Or, even if they are identified, the identification may simply be the identification of a designer, and not include the specific item or where it can be purchased.

Finally, many magazines, television shows, and newspapers are becoming increasingly available online. In the preceding examples, if an item is identified in some text associated with a photograph, a hyperlink to the item may also be provided. In a medium such as this, advertisers can get a better measure of the effectiveness of advertisements because clicks through the hyperlinks can be tracked. This allows advertisers to determine an appropriate price to pay for an advertisement based on the volume of traffic the advertisement generates.

In a first illustrative embodiment, an online image or movie is used to provide product advertising. The image or movie can be any type of image or movie, and does not need to be specifically tailored for the advertisement of a particular product. For example, a picture of a celebrity at an event may be shown.

In this example, each or some of the items the celebrity is wearing (shoes, sunglasses, dress, handbag, etc.) may be hyperlinked in the picture itself. That is, instead of providing a text-based description of one or more products, a user may be able to mouse over the specific item he or she is interested in and be directly linked to the product by clicking. That is to say, it is not the entire picture itself that is linked, but one or more of numerous purchasable items within the picture are linked to individual sites where that item can be purchased. This can allow almost any photograph to be turned into an advertisement, as well as allowing the photograph to convey whatever original meaning was intended.

Since no extra text is necessary to provide access to the products, there is no distraction from the original intent of the photograph. For example, an article in an architectural magazine may show the design of a room in connection with an article about the building in which the room exists. It may not be common for such an article to include the particulars of the items shown in the photograph, since the article is about the building. But, with the exemplary illustrative embodiments, any photograph, including one such as mentioned above, can be turned into a dynamic advertisement, linking the items contained therein to the sites where they can be purchased. Such linking can be done via individual hyperlinks for each item, even though the photograph may not be a photograph typically used for advertising an item. An editorial picture in an article can thus be dynamically transformed into an advertisement providing a plurality of purchasable goods.

In a further illustrative embodiment, moving images, such as a television show or a movie can also potentially contain dynamic advertisements. Since the images can be moused over while being viewed online, hyperlinked advertising can be accessed.

In one illustrative embodiment, a method of electronic advertising includes displaying an image showing a plurality of purchasable goods. The method further includes providing selectable portions of the image, wherein a plurality of the selectable portions are each substantially defined by the perimeter of one of the purchasable goods.

The method also includes detecting a selection of a selectable portion and displaying a browser window. The browser window (which may include a window already being displayed) includes at least a portion of the window provided by a seller of a given purchasable good in response to selection of the selectable portion corresponding to the given selectable good. Finally, the method includes tracking selections of selectable portions, wherein at least two of the purchasable goods are provided by different sellers. In this embodiment the tracking is tracked separately for each of the sellers.

In a second illustrative embodiment, a method of electronic advertising includes determining a plurality of portions of an image that are to be designated as mouse-clickable portions. In this embodiment, each of the mouse-clickable portions corresponds to a single item to be offered for sale. At least two of the items are provided by different sellers in this illustrative embodiment.

Finally in this illustrative embodiment, the method includes designating each of the plurality of portions as mouse-clickable portions and providing a hyper-link in conjunction with each of the mouse-clickable portions. When a given mouse-clickable portion is clicked on by a user, the hyper-link causes a web browser to display a site offering the item shown in the mouse-clickable portion for sale.

In still a third illustrative embodiment, a computer readable storage medium, stores one or more instructions executable by a computer reading the computer readable storage medium.

In this illustrative embodiment, the instructions cause the computer to display an image having a plurality of designated mouse-clickable portions, wherein at least two of the mouse-clickable portions correspond to purchasable goods provided by different sellers.

The computer is also caused to detect a mouse click on one of the mouse-clickable portions. The computer is further caused to, in response to the mouse click, display a website offering for sale an item displayed in the mouse-clickable portion.

### BRIEF DESCRIPTION OF THE DRAWINGS

FIG. 1a shows an illustrative example of a photograph includable with an online article;

FIG. 1b shows a view of the photograph shown in FIG. 1a, with exemplary hyperlinked portions displayed;

FIG. 1c shows a view of the photograph shown in FIG. 1b, with an exemplary pop-up display shown;

FIG. 2 shows an illustrative example of a process for displaying an image having differing selectable portions;

FIG. 3 shows an illustrative example of a second process for displaying an image in accordance with FIG. 2, including a process for displaying a tool-tip; and

FIG. 4 shows an illustrative example of a process for preparing an image for multiple item selectability and purchasability.

### DETAILED DESCRIPTION OF ILLUSTRATIVE EMBODIMENTS

### Insert Boilerplate

Detailed embodiments of the present invention are disclosed herein. However, it is to be understood that the disclosed embodiments are merely exemplary of an invention that may be embodied in various and alternative forms. Therefore, specific functional details disclosed herein are not to be interpreted as limiting, but merely as a representative basis for the claims and/or as a representative basis for teaching one skilled in the art to variously employ the present invention.

Although described as methods in the illustrative examples presented herein, each of the methods can also be automatically performed by, for example, a computer reading a computer readable storage medium storing instructions (such as, but not limited to, a hard disk drive, a CD, a DVD, a flash drive, etc.). The computer receiving the instructions can execute them to perform the various illustrative embodiments.

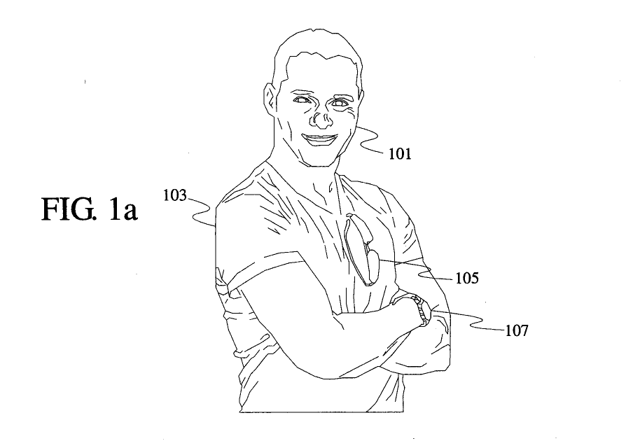

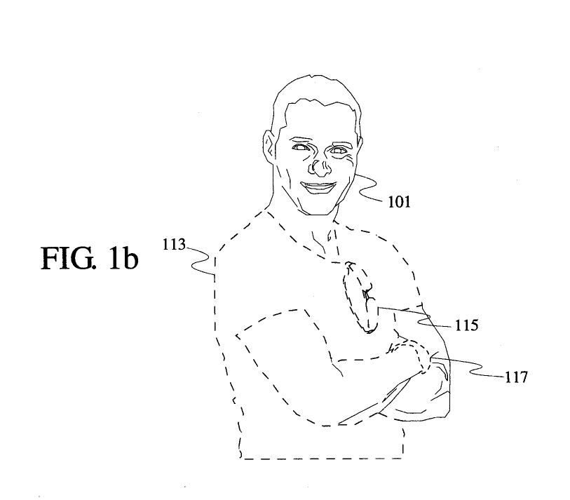

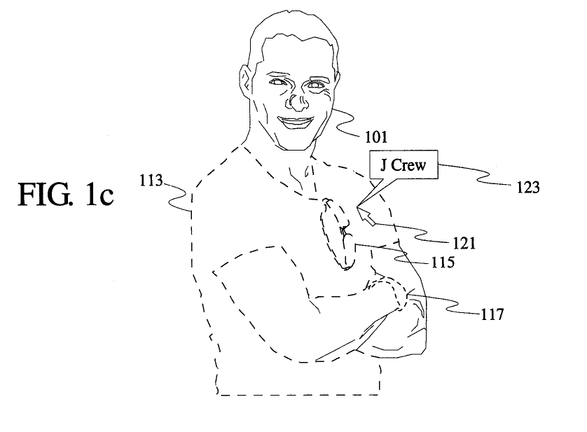

FIG. 1a shows an illustrative example of a photograph includable with an online article. The photograph is shown in wire frame form for the sake of this application, but it is intended that the illustrative embodiments are applicable to actual photographs, whether those photographs were shot for advertising purposes or otherwise, as well as generated images and/or video/movie footage (including electronically generated movies).

In this illustrative embodiment, a photograph has been taken of a celebrity 101 for inclusion with an online article to be published on a website. While applicable to photographs taken for advertisement purposes, this illustrative example is directed at a photograph taken for purposes of the article, but not necessarily originally intended for advertisement purposes.

In this photograph shown in FIG. 1, the celebrity 101 is wearing three items that are possible to buy. He is wearing a t-shirt 103, a pair of sunglasses 105, and a watch 107. Although the picture was not taken to advertise these items, it is within the consideration of the illustrative embodiments that these items could be offered easily for sale.

Since there are numerous such photographs provided in online articles and the like, each item in each photograph could potentially provide advertisement revenue. This can be an entirely new source of revenue for producers of online magazines, newspapers, blogs, etc. Further, since each of the items is likely made by a different seller (or designer, etc.), each photograph can provide advertisement revenue from a plurality of sources.

Selections of the various items in the photographs can be tracked in order to inform advertisers and/or set a base for the cost of the advertisements.

FIG. 1b shows a view of the photograph shown in FIG. a, with exemplary hyperlinked portions displayed. In this illustrative embodiment, each of the three items, the t-shirt, the sunglasses and the watch is available for purchase.

Although the perimeter definitions (shown by dashed lines in FIG. 1b) of the objects may not be seen by the user, they can be defined to outline the various items that are purchasable in a given image. For example, in this image, the t-shirt has a clickable area defined by the perimeter 113. The sunglasses have a clickable area that is defined by the perimeter 115, and the watch has a clickable area that is defined by the perimeter 117.

In this illustrative embodiment, clickable areas are defined by perimeters that look like the objects that they are associated with. Since this could possibly present a great deal of work to do manually, defining these perimeters may be done by an automated program. Alternatively, the objects may simply be surrounded by a simply shaped perimeter (square, circle, or even a simple general polygon or smooth shape) that more basically defines the object as selectable. For example, in the picture shown, a large rectangle could define the t-shirt, and smaller rectangles could define the watch and sunglasses. Any suitable means of designating the various objects is acceptable.

Although the clickable areas may not be shown, a visual cue may be provided to the user to indicate that one or more areas of an image are clickable. This could be, for example, an icon on the picture used to designate interactability, a set of instructions, an outline of the clickable portions, etc.

FIG. 1c shows a view of the photograph shown in FIG. 1b, with an exemplary pop-up display shown. In this illustrative embodiment, it is desired to provide additional information to a user regarding one or more of the various items offered for sale in the photograph.

In this illustrative embodiment, a mouse cursor 121 can be positioned over the various clickable portions (113, 115, 117) in the photograph. Positioning of the cursor over a clickable portion causes a pop-up window 123 to appear.

In the shown illustrative embodiment, the pop-up window includes a designer of the t-shirt over which the cursor is positioned. In other illustrative embodiments, additional information may be included.

Using the pop-up information, users can obtain information about a product before clicking on it, providing a more informational browsing/shopping experience.

Although a celebrity wearing clothing has been shown for illustrative purposes, the illustrative embodiments are not limited to clothing. Purchasable goods under the illustrative embodiments can include, but are not limited to automobiles, travel packages, restaurants and restaurant reservations, household items, electronics, books, movies, etc. It is the intent of the inventors that the illustrative embodiments be usable for advertising any item that may appear in an electronic image, to the extent that there is a market for that item.

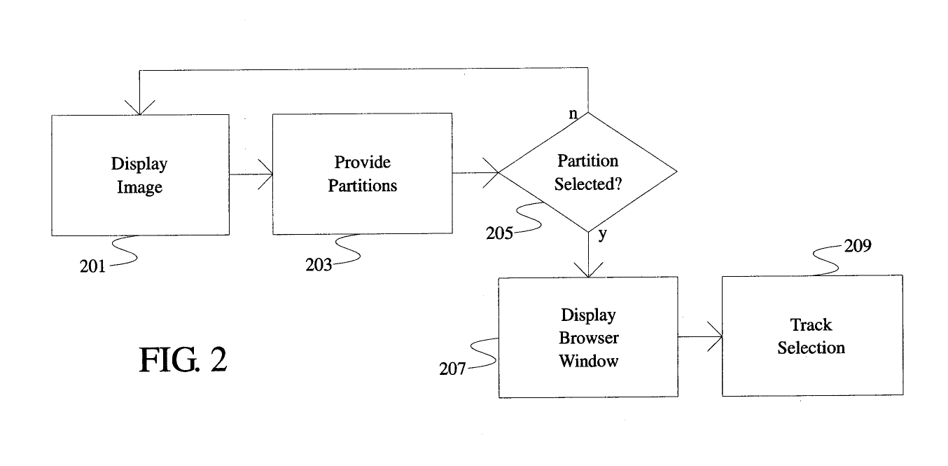

FIG. 2 shows an illustrative example of a process for displaying an image having differing selectable portions. In this illustrative non-limiting embodiment, an image is first displayed 201. The image can be a photograph, an advertisement, a computer generated image, etc. A video could also be displayed, or a computer generated movie, such as a FLASH movie.

Partitions are also provided 203. In this illustrative embodiment, the partitions define various portions of the image corresponding to purchasable goods. For example, the partitions could define the t-shirt, watch and sunglasses shown in FIG. 1a.

The partitions may be defined by the perimeters of the purchasable objects, or they may be polygons or smooth shapes more generally surrounding an image.

In this illustrative embodiment, it is then determined whether a selectable portion has been selected 205. If a partition has not been selected, the image and the partitions continue to be displayed (the partitions themselves may not be visible to a user).

If a partition has been selected, a website or browser window is then displayed 207 including, but not limited to, for example, a sub-display (such as a frame) within a browser window presently being viewed, a separate browser window, a separate tab (such as provided by INTERNET EXPLORER), etc. In some manner, display of a window is provided such that at least a portion of the window corresponds to the purchasable good and is provided by a seller of the purchasable good.

Finally, in this illustrative embodiment, the selection is also tracked 209. The selection can be tracked, for example, by seller (e.g., without limitation, if the seller makes more than one good displayed in the image) or it can be on a product by product basis. Tracking aids in determining the effectiveness of the advertising and allows, for example, the vendor providing the medium through which the advertising is performed to set pricing appropriately.

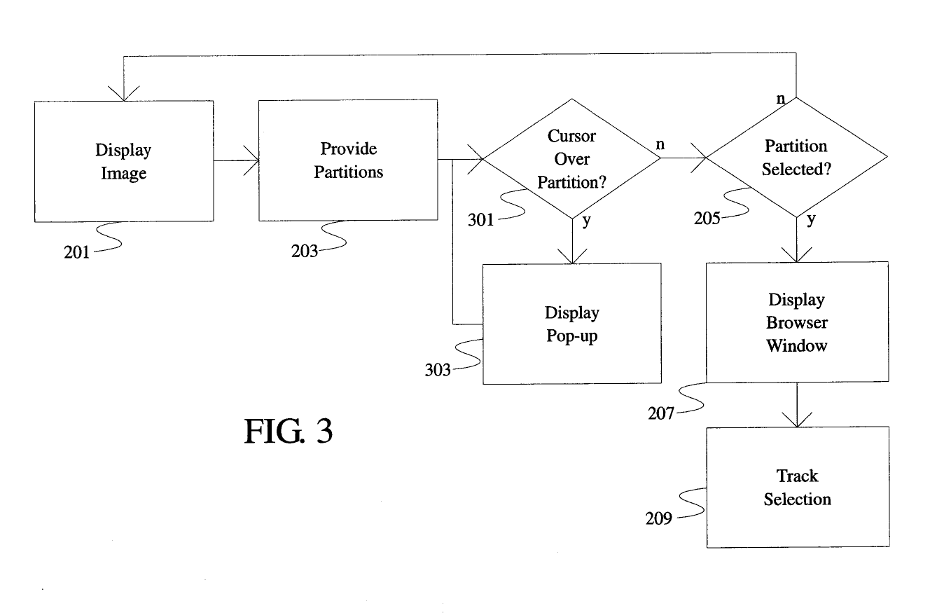

FIG. 3 shows an illustrative example of a second process for displaying an image in accordance with FIG. 2, including a process for displaying a tool-tip. In this illustrative embodiment, extra determinations are provided once partitioned portions of an image have been provided.

Here, after the partitions are provided 203, a determination is made as to whether or not a cursor is over a partition 301. The cursor may be required to rest in a stationary position over a partition for a period of time, to pass over the partition in any manner, or to remain within a partition (while moving for example) for a period of time.

If the determination is made that a pop-up is appropriate, then a pop-up is displayed in any suitable fashion 303.

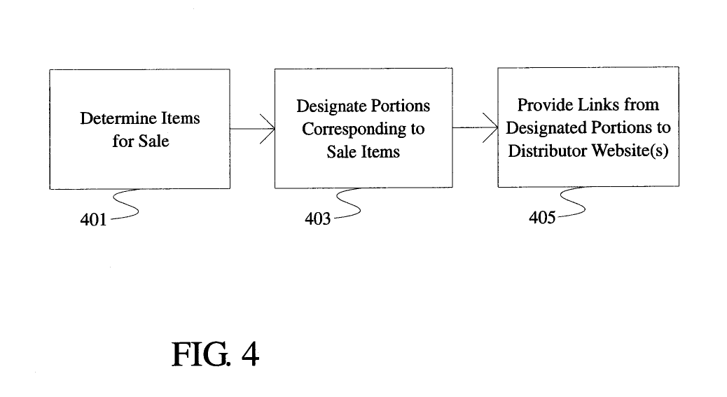

FIG. 4 shows an illustrative example of a process for preparing an image for multiple item selectability and purchasability. In this illustrative embodiment, an image is examined and it is determined which items in the image are purchasable and/or desired to be made purchasable through display of the image 401.

Portions of the image are then designated as selectable portions 403. These portions correspond to the purchasable goods. As previously noted, such designations can correspond to the perimeters of the items, they can be polygons or smooth shapes surrounding an object or including substantial portions of the object.

Finally, in this illustrative embodiment, links are provided to the portions corresponding to the purchasable goods 405. These links can cause new windows to open when clicked, cause a change in the state of the present window, cause a new tab to open, etc.

While various exemplary, illustrative, non-limiting embodiments have been described in detail, those familiar with the art to which this invention relates will recognize various alternative designs and embodiments for practicing the invention, which is only limited by the following claims.

I claim:

1. A method of electronic advertising comprising:
displaying an image showing a plurality of purchasable goods;
providing selectable portions of the image, wherein a plurality of the selectable portions are each substantially defined by the perimeter of one of the purchasable goods;
detecting a selection of a selectable portion;
displaying a browser window including at least a portion of the window provided by a seller of a given purchasable good in response to selection of the selectable portion corresponding to the given selectable good; and
tracking selections of selectable portions, wherein at least two of the purchasable goods are provided by different sellers, and wherein the tracking is tracked separately for each of the sellers.

2. The method of claim 1, wherein the image is a photograph.

3. The method of claim 2, wherein the photograph is a photograph not originally taken for purposes of advertising at least one of the purchasable goods for which a selectable portion is provided.

4. The method of claim 1, wherein the tracking is separately tracked for each of the purchasable goods.

5. The method of claim 1, further comprising tracking purchases of the purchasable goods, wherein the purchases are tracked separately for each of the sellers.

6. The method of claim 5, wherein the tracking purchases is separately tracked for each of the purchasable goods.

7. A method of electronic advertising comprising:
determining a plurality of portions of an image that are to be designated as mouse-clickable portions, wherein each of the mouse-clickable portions corresponds to a single item to be offered for sale, and wherein at least two of the items are provided by different sellers;
designating each of the plurality of portions as mouse-clickable portions;
providing a hyper-link in conjunction with each of the mouse-clickable portions, such that, when a given mouse-clickable portion is clicked on by a user, the hyper-link causes a web browser to display a site offering the item shown in the mouse-clickable portion for sale.

8. The method of claim 7, wherein each of the mouse-clickable portions corresponds to a single item to be offered for sale.

9. The method of claim 7, further including providing a pop-up display in conjunction with one or more of the mouse-clickable portions, such that when a mouse cursor is placed over a given mouse-clickable portion having a pop-up display associated therewith, the pop-up display is shown.

10. The method of claim 7, wherein the pop-up display includes an item name.

11. The method of claim 10, wherein the pop-up display includes an item designer or seller.

12. The method of claim 10, wherein the pop-up display includes an item price.

13. The method of claim 7, further including providing a visual cue to a user that the image is an interactive image.

14. The method of claim 7, wherein each of the plurality of mouse-clickable portions designates an item shown in the image.

15. The method of claim 14, wherein one or more of the designations is defined by a perimeter of the item.

16. The method of claim 14, wherein one or more of the designations is defined by a polygon or a smooth shape generally including the item or surrounding the item.

17. A computer readable storage medium, storing one or more instructions that cause a computer reading the computer readable storage medium and executing the instructions to perform the steps comprising:
displaying an image having a plurality of designated mouse-clickable portions;
detecting a mouse click on one of the mouse-clickable portions;
in response to the mouse click, displaying a website offering for sale an item displayed in the mouse-clickable portion.

18. The computer readable storage medium of claim 17, wherein at least two of the mouse-clickable portions each correspond to a single item displayed in the image.

19. The computer readable storage medium of claim 17, wherein at least two of the mouse-clickable portions are each defined by a perimeter of the item to which the mouse-clickable portion corresponds.

20. The computer readable storage medium of claim 17, wherein the computer reading the computer storage medium and executing the instructions stored thereon is further caused to perform the steps of:
detecting whether a cursor is positioned over an advertisement portion; and
upon detecting a cursor being positioned over an advertisement portion, displaying a pop-up display showing one or more pieces of information about an item.
